(19) United States
(12) Patent Application Publication
(10) Pub. No.: US 2005/0075989 A1
(43) Pub. Date: Apr. 7, 2005

(54) Method for securely storing objects

(75) Inventors: Theresa Biasi, Shelton, CT (US); Thomas J. Foth, Trumbull, CT (US); Linda A. Nazareth, Stamford, CT (US); Richard W. Heiden, Shelton, CT (US)

Correspondence Address: Pitney Bowes Inc.;Intellectual Property and Technology Law Dept., 35 Waterview Drive, P.O. Box 3000, Shelton, CT, 06484, US

(73) Assignee: Pitney Bowes Incorporated, Stamford, CT (US)

(21) Appl. No.: 10/955,730

(22) Filed: Sep. 30, 2004

Related U.S. Application Data
(60) Provisional application No. 60/509,640, filed on Oct. 7, 2003.

(51) Int. Cl. G06F 17/60

(52) U.S. Cl. 705/404; 705/410

(57) ABSTRACT

A method for temporarily assigning secure boxes for the transfer of objects when the person who placed the objects in the box and the person who removed the objects from the box are known to the administrator of the system, wherein the system is not owned by the people who placed or removed objects from the box. The depositor of the object is informed of the most desirable location of a box for delivering objects to a recipient.

This Application claims the benefit of the filing date of U.S. Provisional Application No. 60/509,640 filed Oct. 7, 2003, which is owned by the assignee of the present Application.

### FIELD OF THE INVENTION

This invention relates to a method for holding objects and, more particularly, to a secure temporary storage method for holding objects.

### BACKGROUND OF THE INVENTION

Temporary security boxes have been used for many years in train stations and airports. A typical train station or airport security box had a key for which the user of the box paid for a specific period of time. The user of the box would open the box with the key, place some object, i.e., letter, mail, suitcase, computer, information, paper, etc., in the box and remove the placed object from the box after a certain period of time elapsed.

Security boxes have also been utilized by companies and universities. Typically, a company or university box is assigned to an individual who is given a key that opens the box. A representative of the company or university would place objects in the box, and the individual who was assigned a key to remove objects from specific boxes would remove the objects.

In some company settings, company employees are mobile, i.e., they have no assigned office or work area. These employees may be assigned to work in different offices in the same office complex on different days of the week. When a first company employee wants to deliver an object to a second company employee, and the first company employee wants assurances that the second company employee received the object, the first company employee may deliver personally the object to the second company employee. The foregoing is difficult if the second employee is a mobile employee who has no permanently assigned work area. The first employee may spend a great deal of time to find the second employee or find someone who is going to be responsible to sign for the object and give the object to the second employee.

One of the problems with the foregoing method is that optimal use of the boxes was not provided since a large number of the boxes were not used for extended periods of time.

Another problem of the prior art is that only one entity is able to place objects in the boxes.

An additional problem of the prior art is that the individual who placed objects in the boxes may be unknown.

An additional problem of the prior art is that the individual who removed objects from the box may be unknown.

A further problem of the prior art is that it was not known what objects were placed in the box, what objects were removed from the box, and when the objects were placed in and removed from the box.

An additional problem with the prior art is that the depositor of the object was not informed of the most desirable location for delivery to the recipient of the object.

### SUMMARY OF THE INVENTION

This invention overcomes the disadvantages of the prior art by providing a temporarily assigned secure box for the transfer of objects when the person who placed the objects in the box and the person who removed the objects from the box are known to the administrator of the system, wherein the system is not owned by the people who placed or removed objects from the box. An additional advantage of the invention is that the depositor of the object is informed of the most desirable location of a box for delivering objects to a recipient.

The invention allows a delivery person or sender to notify the intended recipient of specific object to a specified secure physical location, i.e., particular assigned secure box, where a system enables the delivery person and/or sender to validate the delivery of the specific object. A cluster of delivery boxes may be coupled to the Internet so that the delivery person may register his/her action of placing an object in a secure box that may only be opened by a specified person. When the specified person opens the assigned, secure box, that event is registered with the system and is acknowledged as proof of delivery of the specified object.

### BRIEF DESCRIPTION OF THE DRAWINGS

FIG. 1 is a front view of a plurality of secure boxes controlled by a common user interface;

FIG. 2 is a system block diagram;

FIGS. 3A, 3B and 3C is a process flow chart describing the operating mode; and

FIG. 4 is a top view of an object that may be placed in one or more of the secure boxes shown in FIG. 1.

### DETAILED DESCRIPTION OF THE DRAWINGS

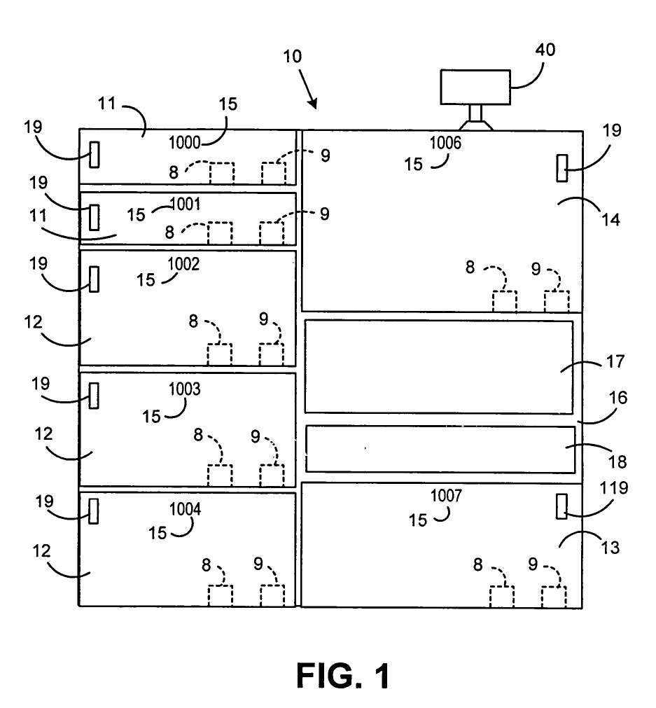

Referring now to the drawings and more particularly to FIG. 1, the reference character 10 represents a cluster of different sized secure delivery boxes. Secure delivery boxes 11 are small in size and may contain small objects, and secure delivery boxes 12 are larger in size than secure delivery boxes 11 and may contain objects larger than those that fit into boxes 11. Secure delivery box 13 is larger than secure box 12, and secure box 14 is larger than box 13. Thus, the largest objects may be placed in box 14. Boxes 11-14 may be identified to users of the system by placing numbers 15 on the outside of boxes 11-14.

Each of the boxes that comprises boxes 11-14 may include a controller 16 that may perform functions such as locking and unlocking the boxes, network interface activities, recording activities, accepting data input from various sources. The system also may include a user interface 17, i.e., key board, touch screen, display, a card scanner, direct input device, etc., (now shown) that is contained within controller 16., and sending messages via various channels (e-mail, voice mail, pager, etc.) interface to browser applications. For the cluster of boxes 10, one controller 16 may control boxes 11-14.

It would be obvious to one skilled in the art that controller 16 may be accessed either directly through a user interface 17 or via a network connection 18. Each box 11-14 is identified by a unique identification code 8 inside the box door, i.e., bar code label. Identification code 8 may be an encrypted bar code, radio frequency identification tag, etc. Each box 11-14 contains multiple scanning devices 9 that notify controller 16 when one or more objects 42 (FIG. 4), i.e., packages, letters flats, documents, samples, etc. are placed in and removed from the box. Thus, a package identification code 41 (FIG. 4) on the object 42 (FIG. 4) may be scanned, and controller 16 will know when the object 41 is placed in and removed from the box. The handle of the box also has a visual indicator 19 that is used to indicate the availability of the boxes 11-14.

A camera 40 is attached to cluster of delivery boxes 10 in a manner that when an individual access one of the boxes 11-14, the individual's image is captured saved and may be linked to the box 11-14 that is being accessed at that point in time with the package identification 41 appearing on the object 42.

Users can access an assigned box through a user interface 17 which may include devices such as a card scanner (to scan employee ID's for example), a keyboard or touch screen input, an infrared beaming device, or with a biometric device (such as fingerprint identification or retinal scan).

It would be obvious to one skilled in the art that each of the boxes 11-14 may have their own controller 16 and user interface 17 for increased security.

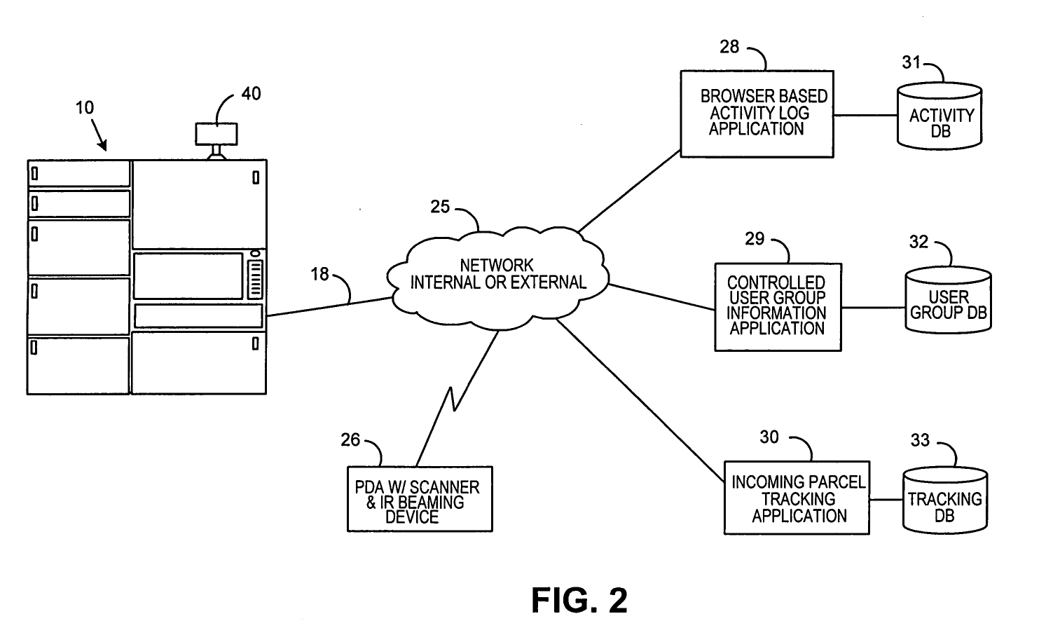

FIG. 2 is a system block diagram showing the connection of cluster of delivery boxes 10 via an internal or external network 25 to PDA with scanner and Infrared beaming device 26 browser based activity log application 28, controlled user group information application 29 and incoming parcel tracking application 30.

Application 28 is coupled to activities database 31 and user application 29 is coupled to user group data base 32. Incoming parcel tracking application 30 is coupled to tracking data base 33. The aforementioned system may operate in a stand alone/local access mode; a network connection/local access mode; or in an integrated delivery tracking system.

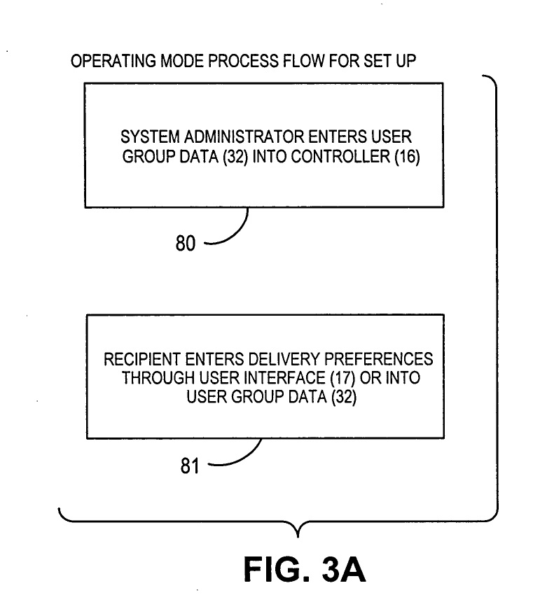

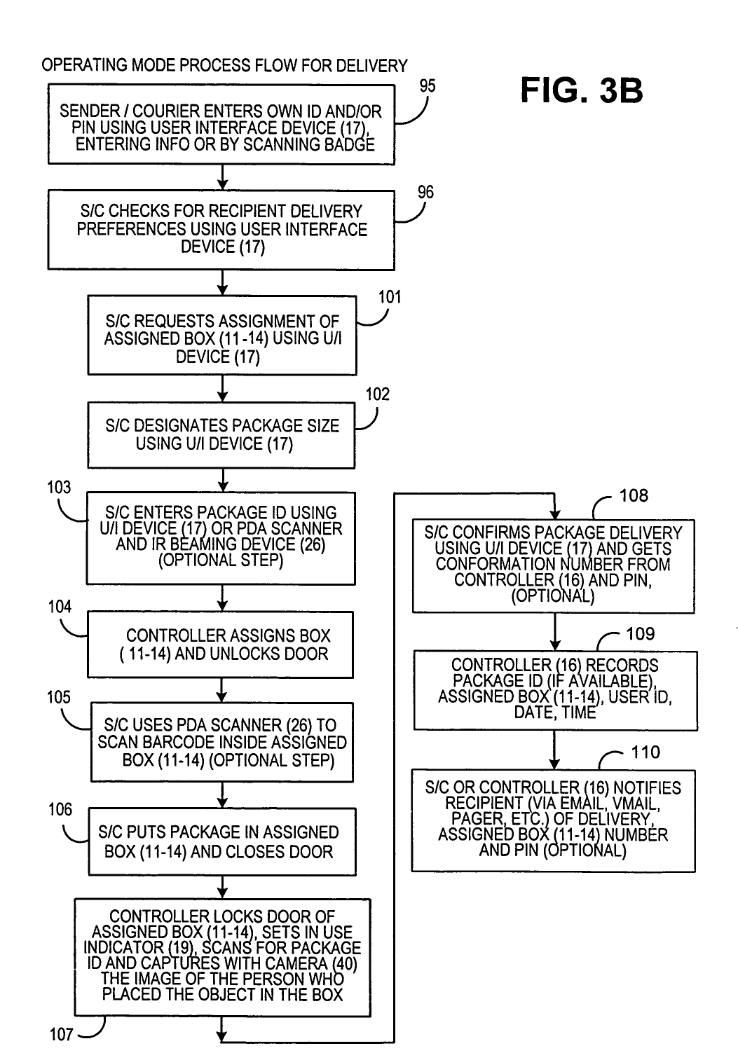

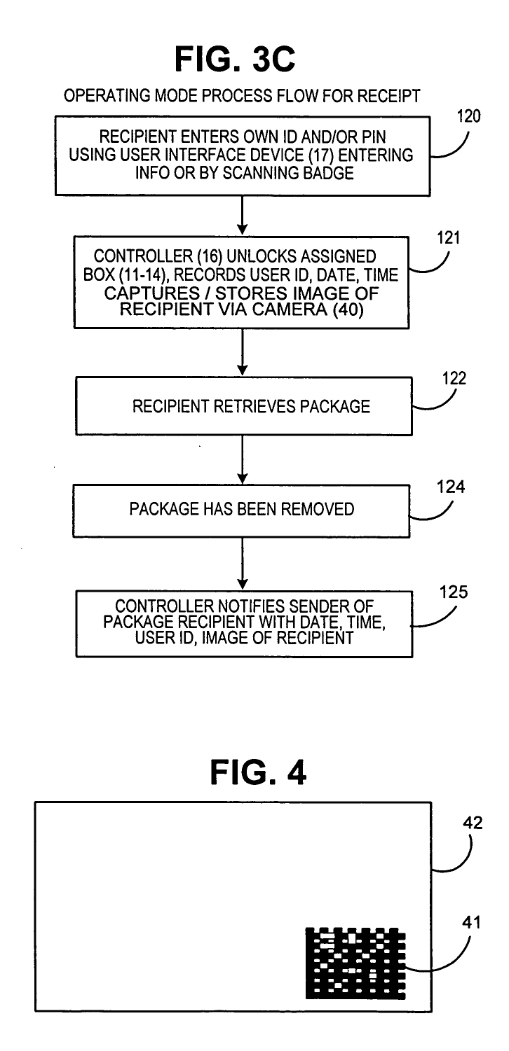

FIGS. 3A, 3B and 3C is a process flow chart describing the operating mode. The setup mode (FIG. 3A) occurs in step 80. In step 80, approved user identifiers are inputted into controller 16 by the system administrator. The foregoing may be accomplished manually through user interface 17 or directly to the controller 16, or through downloading user information from user group data base 32 via network 18.

The set-up mode may also occur in step 81 when the recipient inputs his/her preferences for delivery of objects to a desired location and the manner in which the recipient will be notified of the delivery through interface 17 or into user group data base 32.

The object delivery process begins in step 95 (FIG. 3B) where the sender/courier enters his/her own ID and/or PIN using interface device 17 or by scanning a badge in interface device 17. Then in step 96, the sender/courier checks for recipient delivery preferences using user interface device 17. Then optionally next step 101 the sender/courier may request assignment of a secure delivery locker 11-14 using user interface device 17. Next, in step 102, the sender/courier designates the object's size using user interface device 17. The foregoing is done, because the secure boxes 11-14 have different sizes to accommodate different sized objects. Now, in step 103, the sender/courier enters the object identification using user interface device 17 or PDA scanner 26 IR beaming device. Then in step 104, controller 16 assigns a box 11-14 and opens the door of the assigned box 11-14. Optionally, in step 105, the sender/courier uses PDA scanner 26 to scan unique identification code 8 inside the assigned box. Now, in step 106, the sender/courier places the object in the assigned box and closes the assigned door. Then, in step 107, controller 16 locks the door, sets in use indicator 19, scans the object for the object identification, i.e., package identification code 41, and captures the image of the person who placed object 42 in the assigned box. Then, the process goes to step 108. In step 108, the sender/courier confirms object delivery using user interface device 17 and obtains a confirmation number from controller 16. A personal identification number optionally may be obtained. Then, in step 109, controller 16 records object identification (if available), box 11-14, user ID, date, and time. Then, in step 110, the sender/courier notifies the recipient of the object via e-mail, voice mail, pager, etc. of the delivery of the object, the box number, box location, and, optionally, the personal identification number that will open the box. In the event cluster of boxes 10 are networked, controller 16 may send the above notification automatically and, based upon recipient preferences, as input in Step 81 (FIG. 3A).

Steps 95-110 (FIG. 3B) are used for the object delivery process flow, and the following steps 120-125 (FIG. 3C) are used for the object receipt process flow. In step 120, the recipient enters his/her identification and/or personal identification number, using interface device 17, or by scanning his/her identification badge. Then, in step 121, controller 16 unlocks the assigned box and records information about the recipient who is removing the object, i.e., recipient's identification, and date and time of removal of the object 42 and captures and stores an image of the recipient via camera 40. Then, in step 122, the recipient retrieves object 42. Now, in step 124, the scanner in the box confirms the package has been removed. At this point in step 125, controller 16 notifies the sender of the receipt of object 42 with the date, time, user identification and an image of the recipient of the object 42.

FIG. 4 is a top view of an object that may be placed in one or more of the secure boxes shown in FIG. 1. Object 42 contains a unique package identification code 41. Identification code 41 may be a bar code, encrypted bar code, radio frequency identification tag, etc.

The above specification describes a new and improved secure locker system. It is realized that the above description may indicate to those skilled in the art additional ways in which the principals of the invention may be used without departing from the spirit. It is realized that the above description may indicate to those skilled in the art additional ways in which the principals of the invention may be used without departing from the spirit. Therefore, it is intended that this invention be limited only by the scope of the appended claims.

1. A method for providing a secure box for the transfer of objects from a sender to a recipient, the method comprising the steps of:
A) specifying recipient delivery object preference;
B) notifying by a sender the intention of delivering an object to the recipient;
C) assigning a secure box to the recipient based upon the recipient's preferences and current box availability;
D) unlocking the assigned box;
E) placing an object in the assigned box;
F) locking the assigned box;
G) recording the placing of the object in the assigned box by the sender or the sender's agent, the identification of the object, and the identification of the person who placed the object in the assigned box;
H) notifying the recipient of the delivery of the object to the assigned box;
I) unlocking the recipient assigned box upon the recipient providing appropriate identification; and
J) recording the recipient's removal of the object.

2. The method claimed in claim 1, wherein the recipient preference is the location of the secure box.

3. The method claimed in claim 1, wherein the recipient preference is the recipient stated media in which the recipient will be notified that the object is being placed in a secure box.

4. The method claimed in claim 1, wherein step G, further comprises the step of: capturing an image of the sender or sender's agent who access one of the secure boxes.

5. The method claimed in claim 4, further including the step of: storing the image.

6. The method claimed in claim 5, further including the step of: sending the image of the sender or sender's agent who accessed one of the secure boxes to the recipient.

7. The method claimed in claim 5, further including the steps of: recording the date and time the image was captured, and sending the date and time the image was captured to the recipient.

8. The method claimed in claim 5, further including the steps of: recording a unique identification code the is affixed to the object; recording a unique identification code that is affixed to the secure box; and sending the unique code that is on the object and the unique code that is on the box to the recipient.

9. The method claimed in claim 1, wherein step J, further comprises the step of: capturing an image of the recipient who removes the object from one of the secure boxes.

10. The method claimed in claim 9, further including the step of: storing the image.

11. The method claimed in claim 9, further including the step of: sending the image of the recipient who removes the object from one of the secure boxes to the sender.

12. The method claimed in claim 9, further including the steps of: recording the date and time the image was captured, and sending the date and time the image was captured to the sender.

13. The method claimed in claim 9, further including the steps of: recording a unique identification code the is affixed to the object; recording a unique identification code that is affixed to the secure box; and sending the unique code that is on the object and the unique code that is on the box to the sender.

14. The method claimed in claim 1, wherein the object contains a unique identification code.

15. The method claimed in claim 1, wherein the secure box contains a unique identification code.

16. The method claimed in claim 1, further including the step of: sending the recipient identification of the sender.

17. The method claimed in claim 1, further including the step of: sending the sender identification of the recipient.
